(19) United States
(12) Patent Application Publication
(10) Pub. No.: US 2008/0205077 A1
(43) Pub. Date: Aug. 28, 2008

(54) Lighting System Comprising 2D Led Stack

(75) Inventors: Egbert Lenderink, Eindhoven (NL); Peter Alexander Duine, Eindhoven (NL); Johannes Antonius Adrianus Maria Van Heeswijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,025

(22) PCT Filed: Apr. 11, 2006
(86) PCT No.: PCT/IB06/51099

§ 371 Date: Oct. 9, 2007

(30) Foreign Application Priority Data
Apr. 13, 2005 (EP) 05102917.1

(51) Int. Cl. F21V 8/00

(52) U.S. Cl. 362/555

(57) ABSTRACT

The invention relates to a lighting system (LSI) which comprises a plurality of light engines (LEa_{1,1}, LEa_{2,1}, LEa_{3,1}) and a system-exit window (OS). Each light engine comprising a first predetermined number of light emitting diodes, a second pre-determined number of dichroÊc beam splitters, and an engine-output window. The light engine superposes light emitted by the light emitting diodes via at least one dichroÊc beam splitter on the engine-output window. The lighting system further comprises a plurality of light guides (LGa_{1,1}, LGa_{2,1}, LGa_{3,1}) for guiding light emitted by the light engines towards the system-exit window. The light guides comprise a light-guide-output window (OGa_{1,1}, OGa_{2,1}, OGa_{3,1}) The plurality of light-guide-output windows is arranged in an array constituting the system-exit window. The light guides enable the light engines to be located remotely from the system-exit window. This enables an effective cooling of the light emitting diodes of the light engines while allowing the light-guide-output windows to be stacked adjacent in the system-exit window.

### FIELD OF THE INVENTION

The invention relates to a lighting system comprising a plurality of light engines and a system-exit window, each light engine comprising a first predetermined number of light emitting diodes, a second predetermined number of dichroïc beam splitters, and an engine-output window.

The invention further relates to a lamp and a display device.

### BACKGROUND OF THE INVENTION

High intensity lighting systems usually comprise high-pressure discharge light sources to provide a high intensity output required in these high intensity lighting systems. However, high-pressure discharge light sources have several disadvantages. For example, the light intensity or the color of high-pressure discharge light sources is relatively difficult to influence. Another disadvantage is that a lighting system which comprises a high-pressure discharge light source is often vulnerable for light source failure, which may impact safety, especially when the lighting system is used in, for example, traffic light applications.

High brightness semiconductor light emitters, like Light Emitting Diodes (further also referred to as LED) have become available and are applied more often in high intensity lighting systems. A trend seems to be to apply an array of LEDs, which together form the high intensity light source. Often the outputs of different colors of LEDs are mixed to be able to provide substantially white light from the lighting system. In lighting systems, which comprise LEDs, the output of the LED is typically influenced by the ambient temperature of the LED: thus the ambient temperature of a LED often is a critical parameter in lighting systems, which comprise LEDs.

One example of a lighting system, which comprises a plurality of Light Emitting Diodes, is known from US patent application US 2004/0080938. In this patent application a theatrical or studio lighting system is based on a two dimensional array of light source cubes. Each light source cube comprises three light sources which are preferably directly applied to three different input surfaces of the light source cube. The three light sources preferably represent a LED triad, having one red, one green and one blue light source. The light source cube is a dichroïc prism cube (also known as Philips prism arrangement), which comprises two dichroïc coatings. Each dichroïc coating reflects or transmits light selectively depending on, for example, the wavelength of the light. By choosing appropriate dichroïc coatings within the known light source cube, the light of each of the three light sources is superposed on a single light output Surface of the light source cube.

In a lighting system which comprises a two dimensional array of light source cubes, it is rather difficult to effectively cool the LEDs applied to the different input surfaces of the light source cubes.

### SUMMARY OF THE INVENTION

It is an object of the invention to provide a lighting system which provides a two dimensional array of light source outputs wherein each light source combines the output of a plurality of light emitting diodes and wherein the light emitting diodes can be cooled relatively easily.

According to a first aspect of the invention the object is achieved with a lighting system comprising a plurality of light engines and a system-exit window, each light engine comprising a first predetermined number of light emitting diodes emitting light of a primary color distinct from the primary color of any of the other light emitting diodes in the same light engine, each light emitting diode being provided with a collimator having a longitudinal axis, each light engine further comprising a second predetermined number of dichroïc beam splitters, and an engine-output window, wherein light emitted by each of the light emitting diodes is superposed on the engine-output window via at least one of the dichroïc beam splitters, the lighting system further comprising a plurality of light guides for guiding light emitted by the light engines towards the system-exit window, each light guide having a light-guide-output window, the system-exit window being constituted by an array of light-guide-output windows.

The effect of the measures according to the invention is that the plurality of light guides enables the light engines to be located remotely from the system-exit window. The array of light-guide-output windows of the light guides can be closely stacked in the system-exit window without having an effect on the cooling of the light engines. The light engines are located remotely and can be arranged such that the LEDs can be effectively cooled.

The light engines comprise dichroïc beam splitters. Generally dichroïc beam splitters split light of a light beam into different beams comprising different primary colors. In the light engines according to the invention the beam splitters are used to combine light of different primary colors and superpose the light of different primary colors on the engine-output window.

In an embodiment of the system, the light emitting diodes within each light engine are arranged along a straight line, substantially perpendicular to the longitudinal axis. A benefit of this embodiment is that it further facilitates the cooling of the LEDs, because, for example, a flow of air along to the straight line can be applied for cooling all LEDs within a light engine.

In an embodiment of the system, the light emitting diodes in each light engine are arranged on a single substrate. A benefit of this embodiment is that it enables a single heat sink to be applied to the substrate thus further simplifying the cooling of the LEDs in the light engines.

In an embodiment of the system, the substrates of each light engine are arranged parallel. A benefit of this embodiment is that the cooling of the LEDs in each light engine can be concentrated at one location within the lighting system, for example, at one side of a cover of the lighting system. This arrangement of the light engines, for example, enables a design of the cover such that improved cooling characteristics are assigned to that part of the cover of the lighting system.

In an embodiment of the system, the light-guide-output windows are arranged within the array to form a surface substantially covering the system-exit window. A benefit of this arrangement is that the light-guide-output window can be placed adjacent to each other and thus substantially completely fill the system-exit window. In the known lighting systems, light source cubes are used which comprise three LEDs. The three LEDs are arranged at three input surfaces of each light source cube. When a two dimensional array of light source cubes is formed, some of the LEDs are arranged between two light source cubes which prevents these light source cubes from being placed adjacent to each other within the two dimensional array. The output window of a prior art illumination system, which is formed by an array of light output surfaces of the light source cubes cannot be completely filled with light output Surfaces of the light source cubes.

The lighting system according to the invention comprises light guides, which guide the light from each of the light engines to the light-guide-output windows. By using light guides having a light-guide-output window, the LEDs are located remotely not influencing the arrangement of the light-guide-output windows within the array. The light-guide-output windows are placed adjacent within the array and thus the system-exit window can be substantially completely filled.

In an embodiment of the system, each collimator reduces an angular distribution of the emitted light by the light emitting diodes to within 20 degrees with respect to the longitudinal axis of the collimator. A benefit of this embodiment is that the collimator enables an effective use of LEDs, which have an emission characteristic with a relatively broad angular distribution with dichroïc beam splitters. The dichroïc beam splitters reflect or transmit light selectively depending on, for example, the wavelength of the light and also, for example, on an angle of incidence between the light and the dichroïc layer. Typically the dichroïc beam splitter is designed for an optimum angle of incidence at which the dichroïc beam splitter reflects or transmits light selectively with a relatively high efficiency. The efficiency of the dichroïc beam splitter typically decreases for angles of incident, which are away from the optimum angle of incident. When using the collimator as claimed, the angular distribution of the emitted light is reduced to within 20 degrees and preferably to within 15 degrees from the optimum angle resulting in a relatively high overall efficiency of the dichroïc beam splitters used in the light engines.

In an embodiment of the system, each light guide comprises a rigid light guide for substantially preserving the angular distribution of the light from the collimator. When a flexible light guide would be employed, the angular distribution of the guided light would be typically broadened while guiding the light from the light engine towards the system-exit window. For most light applications, such as spotlights, a narrow angular distribution is preferred. The use of a collimator narrows the angular distribution of the emitted light to, for example, within 15 degrees. The use of a rigid light guide substantially preserves the angular distribution, providing a lighting system having substantially the same overall angular distribution as provided by each one of the collimators.

In an embodiment of the system, the system comprises at least two dichroïc beam splitters, wherein two dichroïc beam splitters are combined into a single beam splitting cube. A benefit of this embodiment is that it enables a compact arrangement of the dichroïc beam splitters and thus enables a compact design of the lighting system.

In an embodiment of the system, each light engine comprises three light emitting diodes. A benefit of using three LEDs is that it enables the creation of substantially every color, including white.

These and other aspects of the invention are apparent from and will be elucidated with reference to the embodiments described hereinafter.

### BRIEF DESCRIPTION OF THE DRAWINGS

In the drawings:

FIG. 1 shows two embodiments of the lighting system according to the invention, in which a first light guide guides the output of a first light engine to a system-exit window of a lighting system,

FIG. 2 shows an embodiment of the lighting system according to the invention, in which a second light guide guides the output of a second light engine towards the system-exit window of the lighting system,

FIG. 3 shows an embodiment of the lighting system according to the invention, in which a third light guide guides the output of a third light engine to the system-exit window of the lighting system, and

FIG. 4 shows a lamp and a display device according to the invention.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE PREFERRED EMBODIMENTS

In the figures, items which may be arranged within an array are reference by suffixes i and j. The suffice i represents a row within the array and the suffice j represents a column within the array. References comprising the suffice i or j are used for generic description of the items they refer to and references in which the suffice i or j is replaced by a number are used for referring to specific items within the array.

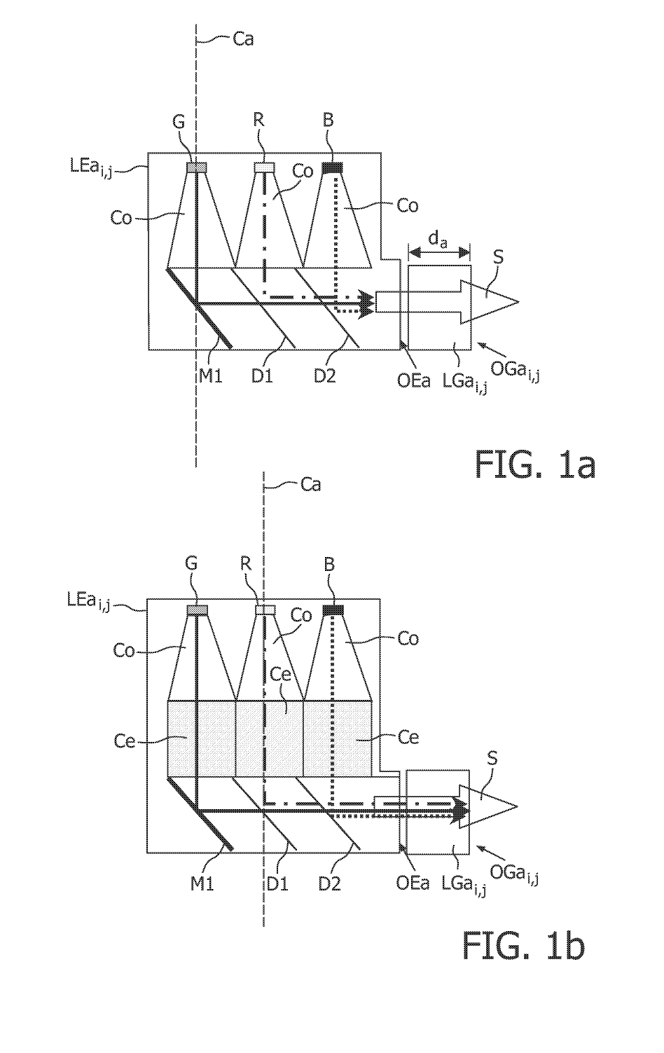

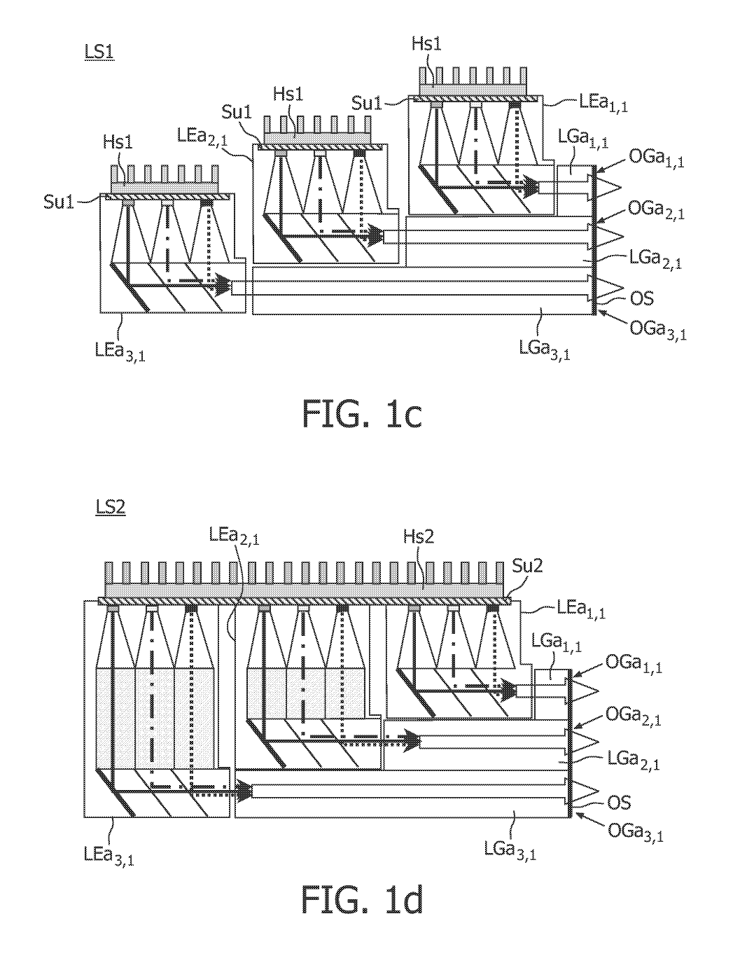

FIG. 1 shows two embodiments of the lighting system LS1 (see FIG. 1c), LS2 (see FIG. 1d) according to the invention in which a first light guide LGa_{i,j} guides the output of a first light engine LEa_{i,j} to a system-exit window OS (see FIGS. 1c, 1d and 1e) of a lighting system LS1, LS2. FIG. 1a shows a side view of the first light engine LEa_{i,j} comprising three light emitting diodes R, G, B as light sources. In operation the LEDs R, G, B within the first light engine LEa_{i,j} each provide light of a primary color distinct from the primary color of any of the other LEDs R, G, B. In this embodiment one LED R emits red light (also indicated as red LED R), one LED G emits green light (also indicated as green LED G) and one LED B emits blue light (also indicated as blue LED B). Of course also other combinations of primary colors can be used. Each LED R, G, B is provided with a collimator Co having a longitudinal axis Ca. The collimator Co reduces an angular distribution of the light emitted by the LEDs R, G, B, for example, to within 20 degrees and preferably to within 15 degrees with respect to the longitudinal axis Ca of the collimator Co. The first light engine LEa_{i,j} further comprises two dichroïc beam splitters D1, D2, a first mirror M1 and an engine-output window OEa. The first dichroïc beam splitter D1 reflects light emitted by the red LED R and transmits light emitted from the green LED G. The second dichroïc beam splitter D2 reflects light emitted by the blue LED B and transmits light emitted from both the green LED G and the red LED R. FIG. 1a also shows the first light guide LGa_{i,j} with a light-guide-output window OGa_{i,j}. The first light guide LGa_{i,j} guides the light output of the first light engine LEa_{i,j} to the light-guide-output window OGa_{i,j}.

In FIG. 1a, the main light path of light emitted by the green LED G is indicated with a solid line. The emitted green light passes through the collimator Co which narrows the angular distribution of the green light. Next, the green light reflects at the mirror M1 towards the engine-output window OEa, passing through the first dichroïc beam splitter D1 and the second dichroïc beam splitter D2. The main light path of light emitted by the red LED R is indicated by a dash-dot line. The emitted red light passes through the collimator Co which narrows the angular distribution of the red light. Next, the red light reflects at the dichroïc beam splitter D1 towards the engine-output window OEa, passing through the second dichroïc beam splitter D2. The main light path of light emitted by the blue LED B is indicated by a dotted line. The emitted blue light passes through the collimator Co which narrows the angular distribution of the blue light. Next, the blue light reflects at the dichroïc beam splitter D2 towards the engine-output window OEa. The arrangement of the first mirror M1 and of the two dichroïc beam splitters D1, D2 enables the light emitted by each of the three LEDs R, G, B to be superposed on the light output Surface OEa of the first light engine LEa_{i,j} creating light output S which is a mixture of the green light, the red light and the blue light. The light output S is guided by the first light guide LGa_{i,j} to the light-guide-output window OGa_{i,j}. The dimension dₐ of the first light guide LGa_{i,j} may be adapted without departing from the scope of the invention.

FIG. 1b shows a side view of the first light engine LEa_{i,j} in which a collimator extension Ce is added at the exit of each collimator Co. The collimator extension enables an extension of the distance between the LEDs and the mirror M1 or the dichroïc beam splitters D1, D2.

FIG. 1c shows a side view of the lighting system LS1 according to the invention in which an array of first light engines LEa_{1,1}, LEa_{2,1}, LEa_{3,1}, provides light to an array of first light guides LGa_{1,1}, LGa_{2,1}, LGa_{3,1}. The light guides LGa_{1,1}, LGa_{2,1}, LGa_{3,1} guide the output of each of the first light engines LEa_{1,1}, LEa_{2,1}, LEa_{3,1} to the light-guide-output windows OGa_{1,1}, OGa_{2,1}, OGa_{3,1}. The dimensions dₐ of the light guides LGa_{1,1}, LGa_{2,1}, LGa_{3,1} facilitate an arrangement of the first light engines LEa_{1,1}, LEa_{2,1}, LEa_{3,1} such that the LEDs R, G, B can effectively be cooled while allowing an adjacent arrangement of light-guide-output windows OGa_{1,1}, OGa_{2,1}, OGa_{3,1} at the lighting system-exit window OS. In the embodiment of the lighting system LS1 as shown in FIG. 1c, the LEDs within each first light engine LEa_{1,1}, LEa_{2,1}, LEa_{3,1} are arranged on a substrate Su1. The substrate Su1 further comprises a heat sink Hs1. The array of light-guide-output windows OGa_{1,1}, OGa_{2,1}, OGa_{3,1} forms the system-exit window OS of the lighting system. A front view of the lighting system LS1 is shown, for example, in FIG. 1e. From both FIG. 1c and FIG. 1e it will be clear that each first light engine LEa_{1,1}, LEa_{2,1}, LEa_{3,1} comprises a substrate Su1 and that the system-exit window OS of the lighting system is constituted by a two dimensional array of light-guide-output windows OGa_{1,1} . . . OGa_{3,4}.

FIG. 1d shows a side view of a further lighting system LS2 according to the invention in which an array of first light engines LEa_{1,1}, LEa_{2,1}, LEa_{3,1}, provides light to an array of first light guides LGa_{1,1}, LGa_{2,1}, LGa_{3,1}. Again, the dimensions dₐ of the light guides LGa_{1,1}, LGa_{2,1}, LGa_{3,1} enable an arrangement of the first light engines LEa_{1,1}, LEa_{2,1}, LEa_{3,1} such that the LEDs R, G, B can effectively be cooled while allowing an adjacent arrangement of light-guide-output windows OGa_{1,1}, OGa_{2,1}, OGa_{3,1} at the lighting system-exit window OS. In the embodiment of the lighting system LS2 as shown in FIG. 1d all LEDs of the first light engines LEa_{1,1}, LEa_{2,1}, LEa_{3,1} arranged in a single column of the lighting system LS2 are arranged on a single substrate Su2. This has been achieved by using collimator extensions Ce at the appropriate collimators Co. The substrate Su2 also comprises a heat sink Hs2. Also in this lighting system LS2, the array of light-guide-output windows OGa_{1,1}, OGa_{2,1}, OGa_{3,1} forms the system-exit window OS of the lighting system LS2. A front view of the lighting system LS2 is shown, for example, in FIG. 1e. From both FIG. 1d and FIG. 1e it will be clear that each column of first light engines LEa_{1,1}, LEa_{2,1}, LEa_{3,1} comprises a substrate Su2 and that the system-exit window OS of the lighting system LS2 is constituted by a two dimensional array of light-guide-output windows OGa_{1,1} . . . OGa_{3,4}.

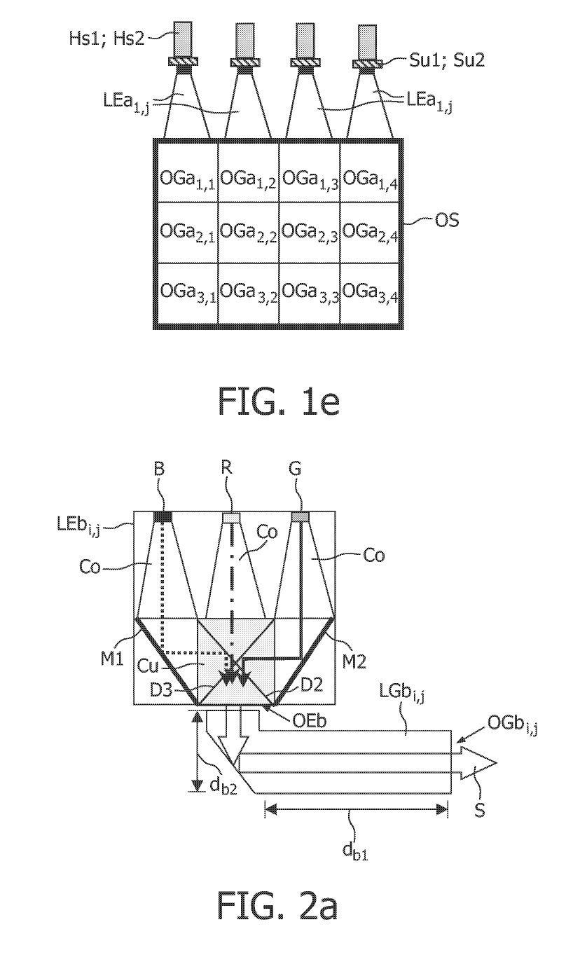

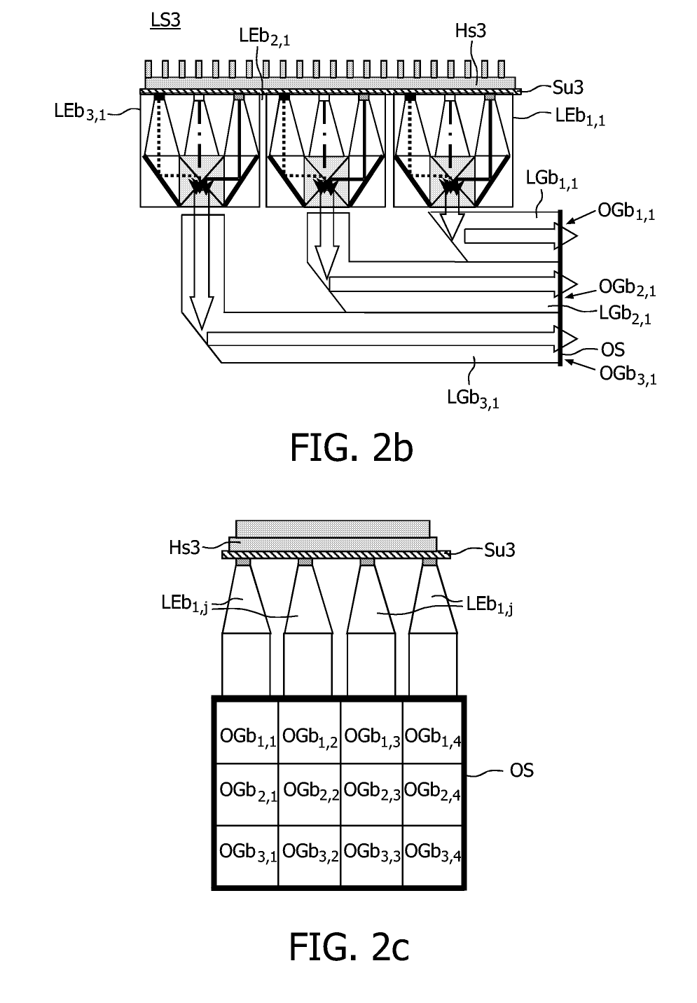

FIG. 2 shows an embodiment of the lighting system LS3 according to the invention in which a second light guide LGb_{i,j} guides the output of a second light engine LEb_{i,j} towards the system-exit window OS of the lighting system LS3. FIG. 2a shows a side view of the second light engine LEb_{i,j} comprising three light emitting diodes R, G, B, each providing light of a primary color distinct from the primary color of any of the other LEDs R, G, B. Each LED R, G, B is provided with a collimator Co which reduces the angular distribution of the light emitted by the LEDs R, G, B, similar to the arrangement shown in FIG. 1a. The second light engine LEb_{i,j} further comprises two dichroïc beam splitters D2, D3, arranged in a dichroïc prism cube, a first mirror M1, a second mirror M2 and a system-output window OEb. The dichroïc beam splitter D2 reflects light emitted by the blue LED B and transmits light emitted from the green LED G and from the red LED R. The second dichroïc beam splitter D3 reflects light emitted by the green LED G and transmits light emitted from both the blue LED B and the red LED R. FIG. 2a also shows the second light guide LGb_{i,j}, which comprises a light-guide-output window OGb_{i,j}. The second light guide LGb_{i,j} guides the output of the second light engine LEb_{i,j} to the light-guide-output window OGb_{i,j}.

In FIG. 2a, the main light path of light emitted by the green LED G is indicated with a solid line. The emitted green light passes through the collimator Co towards the second mirror M2 which reflects the green light towards the dichroïc beam splitter D3. The dichroïc beam splitter D3 reflects the green light towards the engine-output window OEb, passing through the dichroïc beam splitter D2. The main light path of light emitted by the red LED R is indicated by a dash-dot line. The emitted red light passes through the collimator Co and is transmitted by the dichroïc beam splitter D2 and the dichroïc beam splitter D3 towards the engine-output window OEb. The main light path of light emitted by the blue LED B is indicated by a dotted line. The emitted blue light passes through the collimator Co towards the first mirror M1 which reflects the blue light towards the dichroïc beam splitter D2. The dichroïc beam splitter D2 reflects the blue light towards the engine-output window OEb, passing through the dichroïc beam splitter D3. The arrangement of the first mirror M1, the second mirror M2 and of the two dichroïc beam splitters D2, D3 enables the light emitted by each of the three LEDs R, G, B to be superposed on the light output Surface OEb of the second light engine LEb_{i,j} creating light output S which is a mixture of the green light, the red light and the blue light. The light output S is guided by the second light guide LGb_{i,j} to the light-guide-output window OGb_{i,j}. The dimensions d_{b1}, d_{b2} of the second light guide LGb_{i,j} may be adapted without departing from the scope of the invention.

FIG. 2b shows a side view of the lighting system LS3 according to the invention in which an array of second light engines LEb_{1,1}, LEb_{2,1}, LEb_{3,1}, provides light to an array of second light guides LGb_{1,1}, LGb_{2,1}, LGb_{3,1}. The light guides LGb_{1,1}, LGb_{2,1}, LGb_{3,1} guide the output of each of the second light engines LEb_{1,1}, LEb_{2,1}, LEb_{3,1} to the light-guide-output windows OGb_{1,1}, OGb_{2,1}, OGb_{3,1}. The dimensions d_{b1}, d_{b2} of the light guides LGb_{1,1}, LGb_{2,1}, LGb_{3,1} enable an arrangement of the second light engines LEb_{1,1}, LEb_{2,1}, LEb_{3,1} such that the LEDs R, G, B can effectively be cooled while allowing an adjacent arrangement of light-guide-output windows OGb_{1,1}, OGb_{2,1}, OGb_{3,1} at the lighting system-exit window OS. In the embodiment shown in FIG. 2b, all LEDs of the second light engines LEb_{1,1}, LEb_{2,1}, LEb_{3,1} are arranged on a single substrate Su3. The substrate Su3 further comprises a heat sink Hs3. The array of light-guide-output windows OGb_{1,1}, OGb_{2,1}, OGb_{3,1} forms the system-exit window OS of the lighting system. A front view of the lighting system LS3 is shown, for example, in FIG. 2c. From both FIG. 2b and FIG. 2c it will be clear that in the embodiment shown in FIG. 2 the LEDs of each second light engine LEb_{1,1}, LEb_{2,1}, LEb_{3,1} can be arranged on the same substrate Su3 and that the system-exit window OS of the lighting system LS3 is constituted by a two dimensional array of light-guide-output windows OGb_{1,1} . . . OGb_{3,4}.

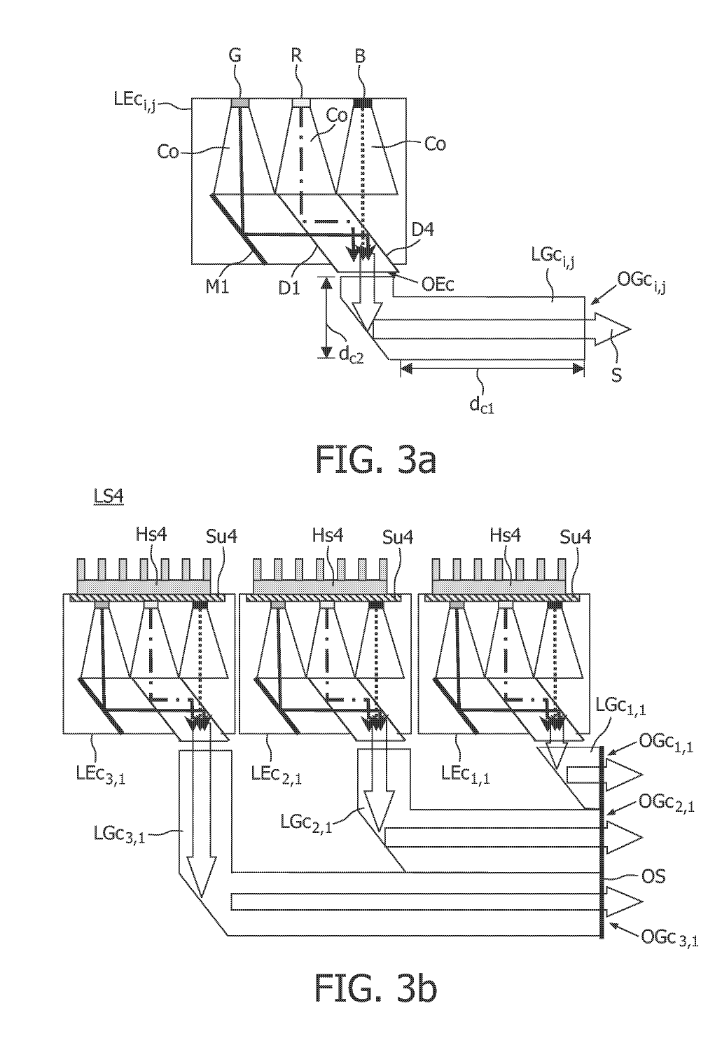

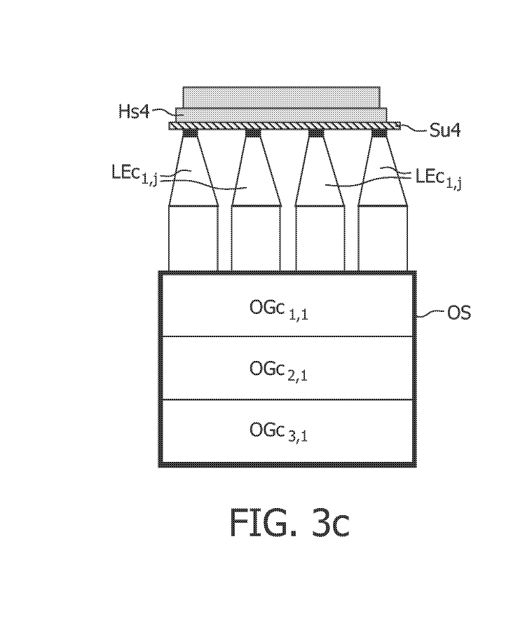

FIG. 3 shows an embodiment of the lighting system LS4 according to the invention, in which a third light guide LGc_{i,j} guides the output of a third light engine LEc_{i,j} to the system-exit window OS of the lighting system LS4. FIG. 3a shows a side view of the third light engine LEc_{i,j} comprising three light emitting diodes R, G, B, each providing light of a primary color distinct from the primary color of any of the other LEDs R, G, B. Each LED R, G, B is provided with a collimator Co which reduces the angular distribution of the light emitted by the LEDs R, G, B, identical to the arrangement shown in FIGS. 1a and 2a. The third light engine LEc_{i,j} further comprises two dichroïc beam splitters D1, D4, a first mirror M1 and an engine-output window OEc. The dichroïc beam splitter D1 reflects light emitted by a red LED R and transmits light emitted from a green LED G. The second dichroïc beam splitter D4 reflects light emitted by both the green LED G and the red LED R and transmits light emitted by the blue LED B. FIG. 3a also shows the third light guide LGc_{i,j}, which comprises a light-guide-output window OGc_{i,j}. The third light guide LGc_{i,j} guides the output of a one-dimensional arrangement of light engines LEc_{1,j} (see FIG. 3c) to the light-guide-output window OGc_{i,j}.

In FIG. 3a, the main light path of light emitted by the green LED G is indicated with a solid line. The emitted green light passes through the collimator Co towards the first mirror M1 which reflects the green light towards the dichroïc beam splitter D4, passing through the dichroïc beam splitter D1. The dichroïc beam splitter D4 reflects the green light towards the engine-output window OEc of the third light engine LEc_{i,j}. The main light path of light emitted by the red LED R is indicated by a dash-dot line. The emitted red light passes through the collimator Co towards the dichroïc beam splitter D1 which reflects the red light towards the dichroïc beam splitter D4. The dichroïc beam splitter D4 reflects the red light towards the engine-output window OEc. The main light path of light emitted by the blue LED B is indicated by a dotted line. The emitted blue light passes through the collimator Co and is transmitted by the dichroïc beam splitter D4 towards the engine-output window OEc. The arrangement of the first mirror M1 and of the two dichroïc beam splitters D1, D4 enables the light emitted by each of the three LEDs R, G, B to be superposed on the light output Surface OEc of the third light engine LEc_{i,j} creating light output S which is a mixture of the green light, the red light and the blue light. The light output S is guided by the third light guide LGc_{i,j} to the light-guide-output window OGc_{i,j}.

FIG. 3b shows a side view of an embodiment of the lighting system LS4 according to the invention in which an array of third light engines LEc_{1,1}, LEc_{2,1}, LEc_{3,1}, provides light to an array of third light guides LGc_{1,1}, LGc_{2,1}, LGc_{3,1}. In the shown embodiment, each light guide LGc_{1,1}, LGc_{2,1}, LGc_{3,1} guides the output of a one dimensional arrangement of third light engines LEc_{1,j}, LEc_{2,j}, LEc_{3,j} (only LEc_{1,j} is shown in FIG. 3c) to the light-guide-output windows OGc_{1,1}, OGc_{2,1}, OGc_{3,1}. The dimensions d_{c1}, d_{c2} of the light guides LGc_{1,1}, LGc_{2,1}, LGc_{3,1} enable an arrangement of the one dimensional arrangement of third light engines LEc_{1,j}, LEc_{2,j}, LEc_{3,j} such that the LEDs R, G, B can effectively be cooled while allowing an adjacent arrangement of light-guide-output windows OGc_{1,1}, OGc_{2,1}, OGc_{3,1} at the system-exit window OS of the lighting system LS4. In the embodiment shown in FIG. 3b, the LEDs of the one-dimensional arrangement of third light engines LEc_{1,j}, LEc_{2,j}, LEc_{3,j} are arranged on a single substrate Su4. The substrate Su4 further comprises a heat sink Hs4. The array of light-guide-output windows OGc_{1,1}, OGc_{2,1}, OGc_{3,1} forms the system-exit window OS of the lighting system LS4. A front view of the lighting system LS4 is shown, for example, in FIG. 3c.

FIG. 3c shows the front view of the embodiment of the lighting system LS4 shown in FIG. 3b.

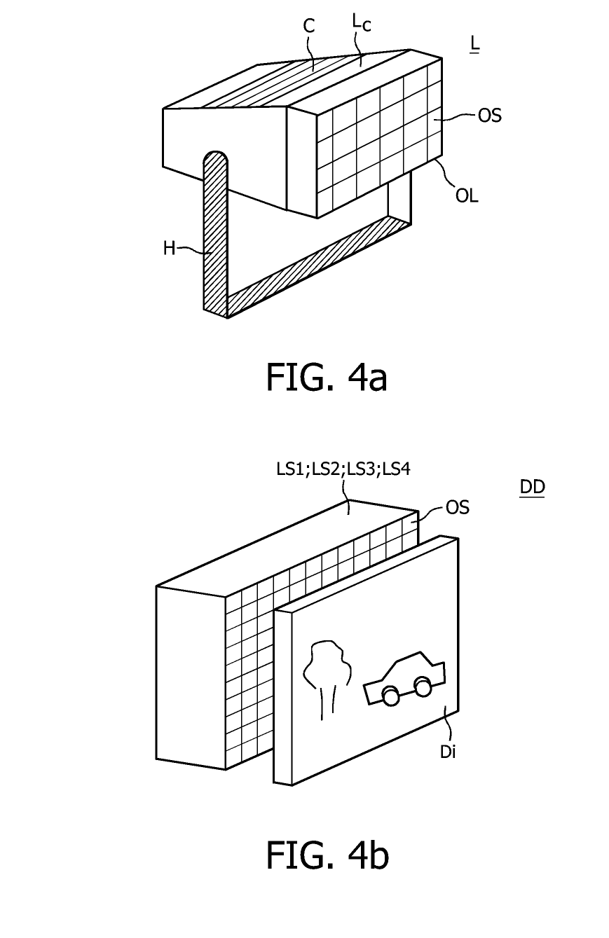

FIG. 4 shows a lamp L and a display device DD according to the invention. FIG. 4a shows a lamp L comprising a cover Lc, a cooling section C, a hinge H and an exit window OL. The exit window OL of the lamp L comprises the system-exit window OS of the lighting system LS1, LS2, LS3, LS4 according to the invention. The heat sink HS1, HS2, HS3, HS4 of the lighting systems shown in the previous figures are concentrated at the cooling section C of the cover Lc. Typically the cooling section C is designed such that improved cooling characteristics are assigned to that part of the cover Lc.

FIG. 4b shows a display device DD comprising a display Di and the lighting system LS1, LS2, LS3, LS4 according to the invention for illuminating the display Di. The display Di of the display device DD may, for example, be a Liquid Crystal panel or, for example, a partially transparent picture for use in a billboard.

The first light guide LGai,j, the second light guide LGbi,j and the third light guide LGc_{i,j} are embodiments of light guides used in the lighting system LS1, LS2, LS3, LS4 according to the invention. The light guides LGa_{i,j}, LGb_{i,j}, LGc_{i,j} enable an arrangement of the light engines LEa_{i,j}, LEb_{i,j}, LEc_{i,j} in the lighting system LS1, LS2, LS3, LS4 such that the LEDs R, G, B, inside the light engines LEa_{i,j}, LEb_{i,j}, LEc_{i,j} can be located remotely from the system-exit window OS, enabling the LEDs to be cooled effectively while allowing an adjacent arrangement of light-guide-output windows OGa_{i,j}, OGb_{i,j}, OGc_{i,j} at the system-exit window OS of the lighting system LS1, LS2, LS3, LS4. The light guides LGa_{i,j}, LGb_{i,j}, LGc_{i,j}, for example, comprise a dielectric material in which the light output S of the light engines LEa_{i,j}, LEb_{i,j}, LEc_{i,j} is confined through total internal reflection. The dielectric material may be flexible or rigid.

Different combinations of light engines LEa_{i,j}, LEb_{i,j}, LEc_{i,j} and light guides LGa_{i,j}, LGb_{i,j}, LGc_{i,j} can be designed by the skilled person without departing from the scope of the invention.

LEDs can be light sources of distinct primary colors, such as, for example the well-known red (R), green (G), or blue (B) light emitters. In addition, the light emitter can have, for example, amber, magenta or cyan as primary color. These primary colors may be either generated directly by the light-emitting-diode chip, or may be generated by a phosphor upon irradiance with light from the light-emitting-diode chip.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. Lighting system (LS1, LS2, LS3, LS4) comprising a plurality of light engines (LEa_{i,j}, LEb_{i,j}, LEc_{i,j}) and a system-exit window (OS),
each light engine (LEa_{i,j}, LEb_{i,j}, LEc_{i,j}) comprising a first predetermined number (N) of light emitting diodes (R, G, B) emitting light of a primary color distinct from the primary color of any of the other light emitting diodes (R, G, B) in the same light engine (LEa_{i,j}; LEb_{i,j}; LEc_{i,j}), each light emitting diode (R, G, B) being provided with a collimator (Co) having a longitudinal axis (Ca), each light engine (LEa_{i,j}, LEb_{i,j}, LEc_{i,j}) further comprising a second predetermined number (M) of dichroïc beam splitters (D1, D2; D2, D3; D1, D4), and an engine-output window (OEa, OEb, OEc), wherein light emitted by each of the light emitting diodes (R, G, B) is superposed on the engine-output window (OEa, OEb, OEc) via at least one of the dichroïc beam splitters (D1, D2; D2, D3; D1, D4),
the lighting system (LS1, LS2, LS3, LS4) further comprising a plurality of light guides (LGa_{i,j}, LGb_{i,j}, LGc_{i,j}) for guiding light emitted by the light engines (LEa_{i,j}, LEb_{i,j}, LEc_{i,j}) towards the system-exit window (OS),
each light guide (LGa_{i,j}, LGb_{i,j}, LGc_{i,j}) having a light-guide-output window (OGa_{i,j}, OGb_{i,j}, OGc_{i,j}),
the system-exit window (OS) being constituted by an array of light-guide-output windows (OGa_{i,j}, OGb_{i,j}, OGc_{i,j}).

2. A lighting system (LS1, LS2, LS3, LS4) as claimed in claim 1, wherein the light emitting diodes (R, G, B) within each light engine (LEa_{i,j}, LEb_{i,j}, LEc_{i,j}) are arranged along a straight line, substantially perpendicular to the longitudinal axis (Ca).

3. A lighting system (LS1, LS2, LS3, LS4) as claimed in claim 2, wherein the light emitting diodes (R; G; B) in each light engine (LEa_{i,j}; LEb_{i,j}; LEc_{i,j}) are arranged on a single substrate (Su1).

4. A lighting system (LS1, LS2, LS3, LS4) as claimed in claim 3, wherein the substrates (Su1, Su2) of each light engine (LEa_{i,j}, LEb_{i,j}, LEc_{i,j}) are arranged parallel.

5. A lighting system (LS1, LS2, LS3, LS4) as claimed in claim 2, wherein the light emitting diodes (R, G, B) of all light engines (LEa_{i,j}, LEb_{i,j}, LEc_{i,j}) are arranged on a single substrate (Su3).

6. A lighting system (LS1, LS2, LS3, LS4) as claimed in claim 1, wherein the light-guide-output windows (OGa_{i,j}, OGb_{i,j}, OGc_{i,j}) are arranged within the array to form a surface substantially covering the system-exit window (OS).

7. A lighting system (LS1, LS2, LS3, LS4) as claimed in claim 1, wherein a light guide (LGa_{i,j}, LGb_{i,j}, LGc_{i,j}) guides light emitted by a plurality of light engines (LEa_{i,j}, LEb_{i,j}, LEc_{i,j}) towards the system-exit window (OS).

8. A lighting system (LS1, LS2, LS3, LS4) as claimed in claim 1, wherein each collimator (Co) reduces an angular distribution of the emitted light by the light emitting diodes (R, G, B) to within 20 degrees with respect to the longitudinal axis (Ca) of the collimator (Co).

9. A lighting system (LS1, LS2, LS3, LS4) as claimed in claim 8, wherein each light guide (LGa_{i,j}, LGb_{i,j}, LGc_{i,j}) comprises a rigid light guide (LGa_{i,j}, LGb_{i,j}, LGc_{i,j}) for substantially preserving the angular distribution of the light from the collimator (Co).

10. A lighting system (LS1, LS2, LS3, LS4) as claimed in claim 1, comprising at least two dichroïc beam splitters (D1, D2; D2, D3; D1, D4), wherein two dichroïc beam splitters (D2, D3) are combined into a single beam splitting cube (Cu).

11. A lighting system (LS1, LS2, LS3, LS4) as claimed in claim 1, wherein each light engine (LEa_{i,j}, LEb_{i,j}, LEc_{i,j}) comprises three light emitting diodes (R, G, B).

12. A lamp (L) comprising the lighting system (LS1, LS2, LS3, LS4) as claimed in claim 1.

13. A display device comprising the lighting system (LS1, LS2, LS3, LS4) as claimed in claim 1 as backlight illumination system.
